(19) United States
(12) Patent Application Publication
(10) Pub. No.: US 2024/0014478 A1
(43) Pub. Date: Jan. 11, 2024

(54) Battery Cover Structure, Battery, Electric Device, and Preparation Method for Battery

(71) Applicant: JIANGSU ZENERGY BATTERY TECHNOLOGIES CO., LTD., Suzhou City (CN)

(72) Inventors: Yongjun LI, Suzhou City (CN); Shengli CHEN, Suzhou City (CN); Zengying YUAN, Suzhou City (CN); Yehui JIAO, Suzhou City (CN); Wuyuan ZOU, Suzhou City (CN)

(21) Appl. No.: 18/220,477

(22) Filed: Jul. 11, 2023

(30) Foreign Application Priority Data
Jul. 11, 2022 (CN) 202210809413.9

(51) Int. Cl. H01M 50/152; H01M 50/593

(52) U.S. Cl. CPC H01M 50/152; H01M 50/593

(57) ABSTRACT

The present disclosure belongs to the technical field of batteries, and specifically relates to a battery cover structure, including: a first cover, a second cover, a third cover and an insulator; the first cover is provided with a first through hole, and the second cover and the third cover are connected and arranged in the first through hole, the insulator is arranged between the first cover and the second cover and between the first cover and the third cover, and the second cover is configured for being electrically connected to an outside, and the third cover is configured for being electrically connected to a first tab; and the second cover and the third cover have the height difference in the first direction, and each of the second cover and the third cover is provided with a welding region.

### CROSS-REFERENCE TO RELATED APPLICATION

The disclosure claims priority to Chinese Patent Application No. 202210809413.9, filed to the China National Intellectual Property Administration on Jul. 11, 2022 and entitled “Battery Cover Structure, Battery, Electric Device, and Preparation Method for Battery” which are incorporated herein by reference in its entirety.

### TECHNICAL FIELD

The present disclosure belongs to the technical field of batteries, and in particular, to a battery cover structure, a battery, an electric device, and a preparation method for a battery.

### BACKGROUND

A lithium ion battery has advantages of light weight, high capacity, long service life, low self-discharge rate, no memory effect, no pollution, etc. Along with the development of modern society, the enhancement of people's environmental awareness and the increasing development of new energy industry, more and more equipments choose lithium ion batteries as power sources, such as a mobile phone, a laptop, an electric tool and an electric vehicle, etc, which provides a wide space for the application and development of lithium ion batteries.

However, in the existing 4680 cylindrical battery, when a negative electrode cover is respectively welded to the outside and the interior of the battery, because welding points are all on the surface of the negative electrode cover, in order to prevent from penetrating into the interior of the battery and damaging the cell when the negative electrode cover is welded to an external busbar, the negative electrode cover will be made thick. However, when the negative electrode cover is welded to a current collector piece or a tab inside the battery, a thicker cover will easily cause faulty soldering. To this end, there is an urgent need for proposing a novel technical solution to solve the described problem.

### SUMMARY

A first object of the present disclosure is: to provide a battery cover structure regarding the shortcomings of the related art; the battery cover structure realizes a battery cover structure in which positive and negative electrodes are located on the same end, thereby improving the space utilization of a battery and also effectively preventing faulty soldering caused when welding a cover to the outside and welding the cover to a current collector piece or a tab.

In order to achieve the object above, the present disclosure adopts the following technical solutions:
a battery cover structure, including: a first cover, a second cover, a third cover and an insulator;
wherein the first cover is provided with a first through hole, the second cover and the third cover are connected and are arranged in the first through hole, the second cover is configured for being electrically connected to an outside, and the third cover is configured for being electrically connected to a first tab; the polarities of the second cover and the third cover are the same, and the polarities of the second cover and the first cover are opposite;
the second cover and the third cover have the height difference in the first direction, and each of the second cover and the third cover is provided with a welding region;
and the insulator is provided between the first cover and the second cover and between the first cover and the third cover, and the insulator is configured to insulate and isolate the first cover from the second cover, and insulate and isolate the first cover from the third cover.

In some embodiments, the height difference between the second cover and the third cover in the first direction is 0.5 mm-3 mm; the second cover is higher than the third cover, the first direction is the thickness direction of the battery cover structure, and an area of the welding region of the second cover and the third cover is not less than 2.5 cm².

In some embodiments, the first through hole includes a first sub hole and a second sub hole in communication with the first sub hole; the first sub hole and the second sub hole are arranged in an arc-shaped structure.

In some embodiments, the insulator includes a first insulator, the first insulator is mounted in the first through hole, a mounting slotted hole corresponding to the first through hole is formed on the first insulator; the second cover and the third cover are mounted in the mounting slotted hole, the shape of the mounting slotted hole respectively matches the shapes of the second cover and the third cover, the second cover is located in the first sub hole, and the third cover is located in the second sub hole.

In some embodiments, the second cover and the third cover are integrally connected or connected in a separate manner, and the separate connection manner is adhesion or snap-fit, etc.

In some embodiments, the battery cover structure has the central position, the first sub hole is located at the central position, at least a part of the first cover forms an annular shape, the annular shape is configured for being electrically connected to the outside, and the annular shape surrounds the second cover and the third cover by taking the central position as the center.

In some embodiments, the first sub hole is a part of a circular sub hole cut along a chord, and the arc corresponding to the first sub hole is a major arc.

In some embodiments, a first protrusion is formed on the second cover, and/or a second protrusion is formed on the annular shape of the first cover.

In some embodiments, the height difference between the first protrusion and the second protrusion is 0.5 mm-5 mm.

In some embodiments, a part of region outside the annular shape in the first cover is configured for being electrically connected to a second tab, and the polarity of the second tab is opposite to that of the first tab.

In some embodiments, a first weak portion for electrically connecting to the first tab is formed on the third cover, a second weak portion for electrically connecting to the second tab is formed on the first cover, and the polarity of the second tab is opposite to that of the first tab.

In some embodiments, the first weak portion and/or the second weak portion are recessed structures.

In some embodiments, the first weak portion avoids the first protrusion, and the second weak portion avoids the second protrusion.

In some embodiments, the first weak portion and the second weak portion are arranged symmetrically relative to the central position.

In some embodiments, the first insulator is adapted to the first through hole, such that the first insulator is sealingly mounted in the first through hole.

In some embodiments, a first raised portion and a first recessed portion are respectively formed at the connection position at the first insulator and the first cover, and the first insulator is clamped with the first cover by the first raised portion and the first recessed portion.

In some embodiments, a plurality of nanopores are formed on the first raised portion or the first recessed portion, and the plurality of nanopores are uniformly distributed at the first raised portion or the first recessed portion.

In some embodiments, the second cover and the third cover are connected to form a cover body, a second raised portion and a second recessed portion are respectively formed at the connection position at the cover body and the first insulator, and the first insulator is clamped with the cover body by the second raised portion and the second recessed portion.

In some embodiments, a plurality of nanopores are formed on the second raised portion or the second recessed portion, and the plurality of nanopores are uniformly distributed at the second raised portion or the second recessed portion.

In some embodiments, the insulator further includes a second insulator extending along the periphery of the bottom of the first insulator and covering a part of the bottom surface of the first cover.

In some embodiments, the first insulator and the second insulator are integrally formed.

In some embodiments, a plurality of nanopores are provided at the connection position at the first cover and the second insulator, and at least a part of the second insulator is embedded into the nanopores.

In some embodiments, the first insulator is provided with a first through port at a position corresponding to the first weak portion, and the second insulator is provided with a second through port at a position corresponding to the second weak portion; the first through port and the second through port is symmetrically arranged according to the central position.

In some embodiments, the battery cover structure further includes a current collector piece; wherein the current collector piece includes a first current collector portion, an insulation connecting portion and a second current collector portion which are connected in sequence; the first current collector portion is arranged on the first through port and partially connected to the first weak portion, and the second current collector portion is arranged on the second through port and partially connected to the second weak portion; and the insulation connecting portion is configured to separate the first current collector portion from the second current collector portion, and the current collector piece avoids an inner wall of the first through hole.

In some embodiments, a connection part between the first current collector portion and the third cover is a first raised portion, and a connection part between the second current collector portion and the first cover is a second raised portion.

In some embodiments, a third through port is provided on a part of the first insulator located in the first sub hole, and the third through port and the insulation connecting portion are respectively provided with connecting structures matching each other.

In some embodiments, the connecting structures are recessed-raised matching structures or clamping structures.

In some embodiments, the first cover, the second insulator, and the insulation connecting portion are correspondingly provided with functional holes.

In some embodiments, the functional holes are configured for liquid injection or pressure relief.

A second object of the present disclosure is to provide a battery, including: a housing provided with an opening at one end, the battery cover structure as described above for closing the opening, and a cell connected to the battery cover structure; wherein the cell is accommodated in the housing, and a positive tab and a negative tab of the cell are both provided on an end of the cell facing the battery cover structure.

In some embodiments, both the positive tab and the negative tab have a semicircular structure.

In some embodiments, the battery further includes an insulation sealing member arranged between the battery cover structure and the housing and isolating the housing from the battery cover structure.

A third object of the present disclosure is to provide an electric device, including the described battery.

A fourth object of the present disclosure is to provide a preparation method for a battery, including the following steps:
preparing a cell of which a positive tab and a negative tab are both located at the same end;
assembling an insulator between a first cover and a second cover and between the first cover and a third cover, so that the insulator, the first cover, the second cover and the third cover form an integrated cover structure;
welding one of the first cover and the third cover to the positive tab of the cell, welding the other of the first cover and the third cover to the negative tab of the cell, and connecting the second cover to an external connecting member; and
mounting the cell into a housing, and connecting an opening of the housing to the first cover in a closed manner.

The beneficial effects of the present disclosure lie in that: 1) in the battery cover structure of the present disclosure, the insulator is provided between the first cover and the second cover, and the first cover and the second cover have different polarities, thereby realizing a battery cover structure in which positive and negative electrodes are located at the same end, and effectively improving the space utilization and energy density of the battery; 2) the second cover is configured for being electrically connected to the outside, the third cover is configured for being electrically connected to the first tab, the second cover is connected to the third cover, the second cover and the third cover have the height difference in the first direction, and each of the second cover and the third cover is provided with a welding region, such that during positioning, while a part electrically connected to the outside and a part electrically connected to the first tab may be efficiently distinguished, the case in the related art that a single position of a cover is operated which easily causes faulty soldering when welding the interior of the battery is avoided; and 3) the second cover and the third cover are provided in the first through hole of the first cover, the first cover, the second cover and the third cover are mounted on the insulator, so that the mounting firmness of the battery cover structure may be improved.

### BRIEF DESCRIPTION OF THE DRAWINGS

Features, advantages, and technical effects of exemplary embodiments of the present disclosure will be described below with reference to the accompanying drawings.

FIG. 1 is an assembly structural diagram of a first insulator and covers according to Embodiments I to III of the present disclosure.

FIG. 2 is a schematic exploded diagram of a first insulator and covers in Embodiments I to III of the present disclosure.

FIG. 3 is a schematic diagram of a dimensional relationship between a first protrusion and a second protrusion according to Embodiment I of the present disclosure.

FIG. 4 is a three-dimensional structural diagram of Embodiment IV of the present disclosure.

FIG. 5 is a schematic exploded diagram of a second cover and a second insulator according to Embodiment IV of the present disclosure.

FIG. 6 is a schematic exploded diagram of Embodiment IV of the present disclosure.

FIG. 7 is a three-dimensional structural diagram of Embodiment VI of the present disclosure.

FIG. 8 is a schematic exploded diagram of Embodiment VI of the present disclosure.

FIG. 9 is an assembly structural diagram of a cell and a battery cover structure according to Embodiment VII of the present disclosure.

FIG. 10 is a schematic three-dimensional diagram of Embodiment VII of the present disclosure.

The reference signs are illustrated as follows:
11—Second cover; 11a—First protrusion; 12—Third cover; 13—First weak portion; T1—First direction;
2—First cover; 20—First through hole; 20a—First sub hole; 20b—Second sub hole; 21—Second protrusion; 22—Second weak portion; 23—Functional hole; H—Height difference between the first protrusion and the second protrusion;
3—Insulator; 31—First insulator; 32—Second insulator; 31a—Mounting slotted hole; 3a—First through port; 3b—Second through port; 3c—Third through port;
4—Current collector piece; 4a—First current collector portion; 4b—Insulation connecting portion; 4c—Second current collector portion; 41—First raised portion; 42—Second raised portion; 43—Third raised portion;
5—Nanopore;
100—Cell; 101—Positive tab; 102—Negative tab;
200—Housing;
300—Insulation sealing member.

### DETAILED DESCRIPTION OF THE EMBODIMENTS

Certain terms are used in e.g. the description and claims to refer to specific components. A person skilled in the art would understand that hardware manufacturers may refer to the same component by using different nouns. The present description and claims do not use differences in names as a manner for distinguishing components, but use differences in functions of components as a criterion for distinguishing. For example, the term “including” mentioned throughout the description and the claims is an open-ended term and should be interpreted as “including but not limited to”. “Approximately” refers to within an acceptable error range, and a person skilled in the art would have been able to solve the technical problem within a certain error range and substantially achieve the technical effect. In addition, the terms “first”, “second” and the like are configured for descriptive purposes only and cannot be construed as indicating or implying relative importance.

In some embodiments of the present disclosure, unless otherwise explicitly specified and limited, terms such as “mount”, “connect” “connected”, and “fix”, etc. should be understood broadly, and for example, is fixed connection, and is detachable connection or integral connection; is mechanical connection, and is electrical connection; is direct connection, and is indirect connection via an intermediate medium; and is communication between the interior of two elements. Orientation or position relationship indicated by terms “up”, “down”, “positive direction”, “negative direction”, etc. is based on the orientation or position relationship as shown in the accompanying drawings. For a person of ordinary skill in the art, the specific meanings of the described terms in the present disclosure could be understood according to specific situations.

The inventor has found that for an existing cylindrical battery, such as a 4680-type cylindrical battery, a positive electrode terminal and a negative electrode terminal thereof are respectively provided at an upper end and a lower end of the cylindrical battery; that is, a cell structure thereof is that a positive tab and a negative tab are lead out from two ends of the cylindrical battery, and such an arrangement not only increases the height of the cylindrical battery; moreover, electrode terminals are provided at both the upper end and the lower end of the cylindrical battery, which easily results in large occupation space and low space utilization of the cylindrical battery, making the energy density of an assembled battery module low. Furthermore, the inventor has also found that the electrical connection between the existing electrode terminal and an outside has a small contact area, and the positive and negative electrode terminals are usually arranged symmetrically when arranged on the same end, so that in the production process, angle positioning needs to be performed on the positive and negative electrodes to achieve welding of the cylindrical battery and the outside, thereby greatly reducing the production efficiency. In addition, the inventor has also found that in the process of cover assembling, because welding points are all on the upper end of the negative electrode cover, in order to prevent from penetrating into the interior of the battery and damaging the cell when the negative electrode cover is welded to an external busbar, the negative electrode cover will be made thick. However, in a process when the negative electrode cover is welded to a current collector piece or a tab, a thick cover will easily cause faulty soldering.

Therefore, in some embodiments of the present disclosure, by improving and optimizing the specific structure of the battery cover structure, the battery cover structure is not only applicable to the case where the positive and negative electrodes of the cylindrical battery are located on the same end, thereby overcoming the defect of low volume energy density of the existing cylindrical battery, but also avoids the case in the related art that a single position of a cover is operated which easily causes faulty soldering when welding the interior of the battery; furthermore, the electrical connection area between the battery cover structure and an outside is enlarged in terms of structure, so that it is not necessary to perform positioning recognition and position placement on the positive and negative electrodes during production processing, effectively increasing the production efficiency.

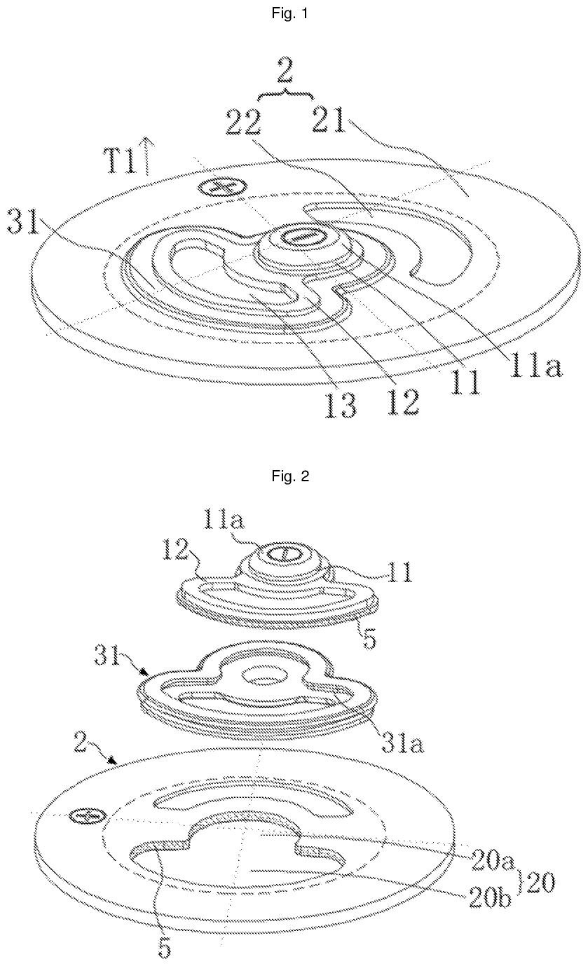

Some embodiments of the present disclosure will be further described in detail below in combination with FIG. 1 to FIG. 10, but the present disclosure is not limited thereto.

### Embodiment I

Hereinafter, Embodiment I is described in combination with FIG. 1 to FIG. 3:

A battery cover structure, including a first cover 2, a second cover 11 and a third cover 12;
wherein the first cover 2 is provided with a first through hole 20, the second cover 11 and the third cover 12 are connected and arranged in the first through hole 20, the polarities of the second cover 11 and the third cover 12 are the same, the polarities of the first cover 2 and the second cover 11 are opposite, the second cover 11 is configured for being electrically connected to the outside, the third cover 12 is configured for being electrically connected to a first tab, and the first tab is a positive tab or a negative tab;
furthermore, the second cover 11 and the third cover 12 have the height difference in the first direction T1, the first direction T1 being the thickness direction of the battery cover structure, the thickness of the second cover 11 is greater than the thickness of the third cover 12, and each of the second cover 11 and the third cover 12 is provided with a welding region. The second cover 11 and the third cover 12 are arranged in a height-staggered manner in the first direction T1, and thus a part electrically connected to the outside and a part electrically connected to the first tab may be efficiently distinguished, and the situation of welding through the cover may be overcome or the occurrence of faulty soldering may be avoided.

In addition, the first cover 2, the second cover 11 and the third cover 12 are respectively mounted on an insulator 3, and the insulator 3 is arranged between the first cover 2 and the second cover 11 and between the first cover 2 and the third cover 12. The insulator 3 is configured to insulate and isolate the first cover 2 from the second cover 11, and insulate and isolate the first cover 2 from the third cover 12, such that the battery cover structure not only forms a battery cover structure in which positive and negative electrodes are located at the same end, but also ensures that both the external connection parts with different polarities and tabs with different polarities do not touch each other, and thus the battery cover structure has excellent operation safety and reliability.

With reference to FIG. 2, the insulator 3 includes a first insulator 31, the first insulator 31 is mounted in the first through hole 20, wherein a mounting slotted hole 31a corresponding to the first through hole 20 is formed on the first insulator 31, the second cover 11 and the third cover 12 are both mounted in the mounting slotted hole 31a, and the shape of the mounting slotted hole 31a respectively matches the shapes of the second cover 11 and the third cover 12.

In the battery cover structure, the first insulator 31 is adapted to the first through hole 20, such that the first insulator 31 is sealingly mounted in the first through hole 20. The material of the first insulator 31 is polypropylene, polyethylene, or nano-plastic, and the material of the covers is metal, so as to form metal covers. When the metal cover serves as a positive electrode, the metal material is one of aluminum, steel, or nickel-plated steel; and when the metal cover serves as a negative electrode, the metal material is one of copper, copper-plated nickel, and copper aluminum composite plate.

Specifically, the first through hole 20 includes a first sub hole 20a and a second sub hole 20b in communication with the first sub hole 20a, the second cover 11 is located in the first sub hole 20a, the third cover 12 is located in the second sub hole 20b; the shape of the second cover 11 matches the shape of the first sub hole 20a, and the shape of the third cover 12 matches the shape of the second sub hole 20b.

In some embodiments, the battery cover structure has a central position, wherein the central position is an intersection point of two crossed auxiliary lines in FIG. 1, the first sub hole 20a is located at the central position, so that the second cover 11 is also located at the central position of the battery cover structure. Furthermore, at least a part of the first cover 2 forms an annular shape, and the annular shape is a part between a circumferential dotted line in FIG. 1 and the outer edge of the first cover 2; the annular shape is configured for being electrically connected to the outside, has a large area, and may effectively increase the contact area of connection between the first cover 2 and the outside.

In order to avoid the situation in the related art that angle positioning needs to be performed on positive and negative electrodes, in an embodiment, the annular shape surrounds the second cover 11 and the third cover 12 by taking the central position as the center. By means of such an arrangement, while parts with different polarities may be efficiently and intuitively distinguished, as the second cover 11 is located at the center of the battery cover structure and the first cover 2 has an annular part arranged along the circumferential direction of the battery cover structure, when the battery cover structure is connected to the outside, it is only necessary to connect electrodes of different polarities of an external electrical connection member to the center of the battery cover structure and the periphery of the battery cover structure, respectively, so as to complete electrical connection; the connection efficiency thereof is high, and there is no need to perform positioning recognition on the positive and negative electrodes and then perform electrical connection. Therefore, compared with the related art, the present solution has higher connection efficiency and assembly efficiency, thereby significantly improving the connection and assembly efficiency of a battery.

In the battery cover structure, a part of region outside the annular part in the first cover 2 is configured for being electrically connected to a second tab, and the polarity of the second tab is opposite to that of the first tab. The electrical connection of the tabs is direct connection or indirect connection, and the direct connection is able to weld, and the indirect connection is auxiliary connection by means of a conductive adhesive or the current collector piece, as long as corresponding electrical connection is achieved.

In an embodiment, refer to FIG. 2, the first sub hole 20a is a part of a circular sub hole cut along a chord, and the arc corresponding to the first sub hole 20a is a major arc, wherein the major arc can effectively ensure and improve the bonding force and bonding strength respectively between the first cover 2 and the first insulator 31 and between the second cover 11 and the first insulator 31. In addition, the inventor has found that if the arc corresponding to the first sub hole 20a is not a major arc, the bonding force respectively between the first cover 2 and the first insulator 31 and between the second cover 11 and the first insulator 31 is poor.

In addition, the first insulator 31 is embedded between the first cover 2 and the second cover 11, and the bonding force respectively between the first cover 2 and the first insulator 31 and between the second cover 11 and the first insulator 31 is 0.8 MPa-5 MPa, 5 MPa-15 MPa, 15 MPa-25 MPa, 25 MPa-35 MPa and 35 MPa-50 MPa.

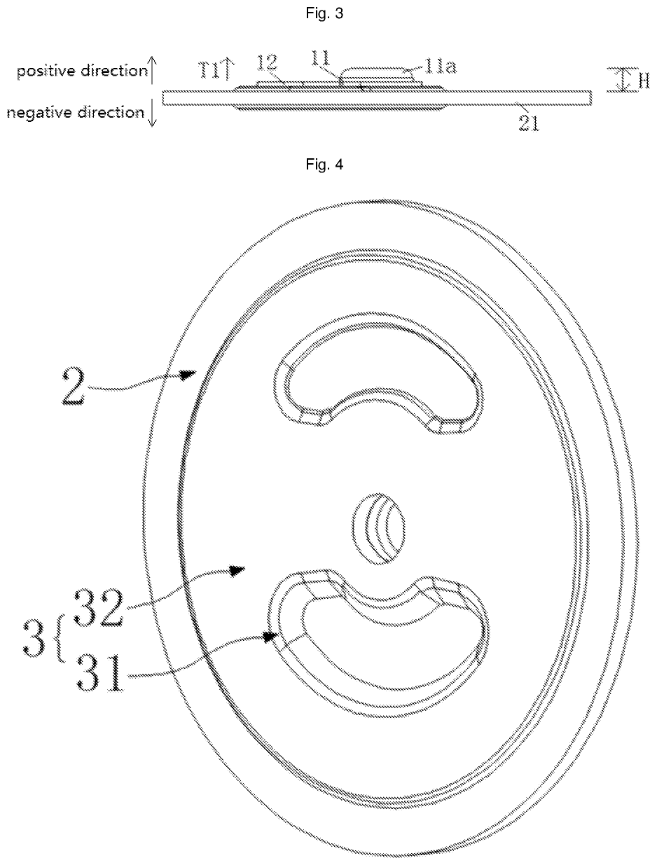

In the battery cover structure, in an embodiment, a first protrusion 11a is formed on the second cover 11, and/or the annular shape of the first cover 2 forms a second protrusion 21. Refer to FIG. 3, the first protrusion 11a is formed by the second cover 11 protruding upward, that is, protruding in a positive direction; and the second protrusion 21 is formed by the first cover 2 protruding upward, that is, protruding in the positive direction. When the battery cover structure has the first protrusion 11a and the second protrusion 21, the height difference between the first protrusion 11a and the second protrusion 21 is H, and the height difference H refers to the height from a starting point, i.e. the end of the second protrusion 21 close to the first protrusion 11a to the topmost part of the first protrusion 11a, and the value range of H is from 0.5 mm-5 mm. By means of such an arrangement, the first protrusion 11a is higher than the second protrusion 21, thereby being able to effectively prevent a short circuit situation caused by contact between different electrical connection pieces externally connected to the second cover 11 and the first cover 2, respectively.

In the battery cover structure, the height difference H between the first protrusion 11a and the second protrusion 21 is 0.5 mm-1 mm, 1 mm-1.5 mm, 1.5 mm-2 mm, 2 mm-2.5 mm, 2.5 mm-3 mm, 3 mm-3.5 mm, 3.5 mm-4 mm, 4 mm-4.5 mm and 4.5 mm-5 mm. Furthermore, the height difference between the second cover 11 and the third cover 12 in the first direction T1 is 0.5 mm-3 mm, specifically, is 0.5 mm-1 mm, 1 mm-1.5 mm, 1.5 mm-2 mm, 2 mm-2.5 mm and 2.5 mm-3 mm.

In addition, the area of the first protrusion 11a is 5 cm²-50 cm², the shape of the first protrusion 11a includes, but is not limited to, a spherical shape, a hemispherical shape, a square column shape, and a truncated pyramid shape; and the area of the second protrusion 21 is 10 cm²-100 cm², and the thickness of the second protrusion 21 is 0.3 mm-20 mm. Any position on the first protrusion 11a and the second protrusion 21 is configured for being electrically connected to the outside, and the current passing capability and flexibility thereof are strong, and there is no need to depend on the size of the existing electrode terminal.

### Embodiment II

Different from Embodiment I, the connection position at the first insulator 31 and the first cover 2 form a first raised portion and a first recessed portion respectively, and the first insulator 31 is clamped with the first cover 2 through the first raised portion and the first recessed portion. In some embodiments, the number of the first raised portion and the number of the first recessed portion may both be one or more, the first raised portion and the first recessed portion are clamped with each other, and the air tightness and the bonding strength between the first insulator 31 and the first cover 2 are improved by means of the recessed-raised fitting manner.

Furthermore, the second cover 11 and the third cover 12 are integrally connected, the second cover 11 and the third cover 12 are connected to form a cover body, and the connection position at the cover body and the first insulator 31 respectively form a second raised portion and a second recessed portion; wherein the number of the second raised portion and the number of the second recessed portion both are one or more, and the first insulator 31 is clamped with the cover body by the second raised portion and the second recessed portion, so as to improve the air tightness and the bonding strength of the connection.

In an embodiment, as shown in FIG. 2, a plurality of nanopores 5 are formed on the first raised portion or the first recessed portion, and a plurality of nanopores 5 are formed on the second raised portion or the second recessed portion, so that at least a part of the first insulator 31 is embedded into the nanopores 5. For example, each of the plurality of nanopores 5 with a pore diameter less than 100 nm is formed on the metal cover by laser engraving or chemical treatment. Since the nanopores 5 have ultra-micro recessed portions, when the first insulator 31 is embedded into the nanopores 5, an anchor effect is formed between the first insulator 31 and the cover body and between the first insulator and the first cover 2, for bonding and fastening, such that the first insulator 31 is efficiently and firmly bonded with the cover body and the first cover 2 respectively, thereby ensuring good air tightness at the connection position respectively between the first insulator 31 and the cover body and between the first insulator and the first cover 2. Moreover, in practical production, the pore diameter and depth of the nanopores 5 and the distance between two adjacent nanopores 5 is adjusted according to actual requirements, and the nanopores 5 is provided only on the cover body or the first cover 2.

Other structures are the same as those in Embodiment I, and will not be repeated here.

### Embodiment III

Different from Embodiment I or Embodiment II, in this embodiment, in order to shorten the distance between the cover and the tabs and increase the reliability of connection or welding between the two, a first weak portion 13 for electrically connecting to a first tab is formed in the third cover 12, a second weak portion 22 for electrically connecting to a second tab is formed in the first cover 2, and the first weak portion 13 and/or the second weak portion 22 are set as recessed structures.

In the battery cover structure, the recessed direction of the recessed structure is opposite to the protruding direction of the first protrusion 11a, that is, the recessed direction of the recessed structure faces downwards, and the recessed structure is recessed in a negative direction; wherein the cross-sectional shape of the recessed structure is square, circular, triangular, trapezoidal, arc-shaped, etc, and is able to be set according to actual requirements, and the size and number of the recessed structures is set according to actual requirements, and the recess depth of the recessed structure is no more than 0.7 mm.

In an embodiment, the first weak portion 13 avoids the first protrusion 11a, and the second weak portion 22 avoids the second protrusion 21; when the battery cover structure has the first weak portion 13 and the second weak portion 22, the first weak portion 13 and the second weak portion 22 are arranged symmetrically relative to the central position of the battery cover structure; and as the first weak portion 13 and the second weak portion 22 are symmetrical, deformation generated when welding tabs are mutually offset.

Other structures are the same as those in Embodiment I or II, and will not be repeated here.

### Embodiment IV

Different from Embodiment III: refer to FIG. 4 to FIG. 6, the insulator 3 of this embodiment further includes a second insulator 32 which extends along the periphery side of a bottom of the first insulator 31 and covers a part of the bottom surface of the first cover 2; wherein the end of the first insulator 31 located in the positive direction of the battery cover structure is the top of the first insulator 31, and the end of the first insulator 31 in the negative direction of the battery cover structure is the bottom of the first insulator 31; and the end of the first cover 2 facing the positive direction of the battery cover structure is the top surface of the first cover 2, and the end of the first cover 2 facing the negative direction of the battery cover structure is the bottom surface of the first cover 2.

Specifically, the first cover 2 encloses at least a part of the first insulator 31, the first insulator 31 encloses the second cover 11 and the third cover 12, and the second insulator 32 isolates the first cover 2 from a main body of the cell, so as to improve the operation safety of the battery.

In an embodiment, the first insulator 31 and the second insulator 32 are integrally formed, and the first insulator 31 and the second insulator 32 are tightly connected by means of integral injection molding and do not easily fall off.

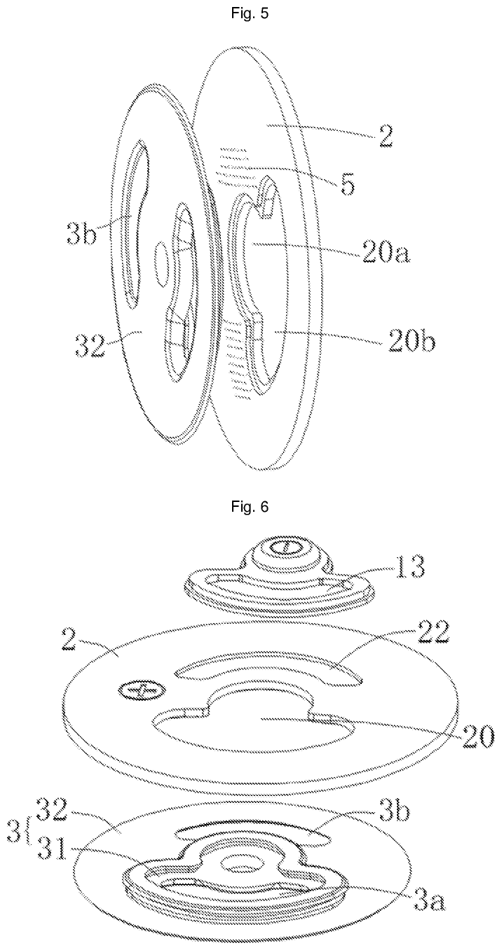

In order to improve the connection strength between the first cover 2 and the second insulator 32, refer to FIG. 5, nanoprocessing is performed on positions where the first cover 2 is in contact with the second insulator 32, so that the connection position at the first cover 2 and the second insulator 32 are provided with a plurality of nanopores 5, and at least a part of the second insulator 32 is embedded into the nanopores 5. The second insulator 32 is provided on a part of the bottom surface of the first cover 2 by means of injection molding, which may satisfy that the first cover 2 and the second insulator 32 are tightly connected and do not easily fall off.

In an embodiment, refer to FIG. 6, the first insulator 31 is provided with a first through port 3a at a position corresponding to the first weak portion 13, and the second insulator 32 is provided with a second through port 3b at a position corresponding to the second weak portion 22; wherein the shapes of the second through port 3b and the first through port 3a are respectively adapted to the shapes of the second weak portion 22 and the first weak portion 13, and are set according to actual requirements, and the second through port 3b and the first through port 3a are both of hollow structures. When tabs are electrically connected to the covers, the first tab passes through the first through port 3a from the bottom of the first insulator 31 and then be connected to the first weak portion 13; and the second tab passes through the second through port 3b from the end of the second insulator 32 facing the negative direction of the battery cover structure and then be connected to the second weak portion 22. When the first tab is connected to the third cover 12 and the second tab is connected to the first cover 2, the second insulator 32 extending from the periphery side of the bottom of the first insulator 31 may effectively prevent the first tab from touching the first cover 2 or prevent the second tab from touching the third cover 12, thereby causing a short circuit situation.

In addition, the first cover 2 has a part that is not covered by the second insulator 32, and when the battery is assembled, the part, not covered by the second insulator 32, of the periphery side of the first cover 2 is sleeved with an insulation sealing member.

Furthermore, the connection manner between the second insulator 32 and the first cover 2 is hot melting, adhesion, and the like, as long as the second insulator 32 and the first cover 2 are tightly connected and do not easily fall off.

Other structures are the same as those in Embodiment III, and will not be repeated here.

### Embodiment V

Different from Embodiment IV: in this embodiment, the second insulator 32 is connected to the first insulator 31 in a separate manner, and the separate connection manner between the second insulator 32 and the first insulator 31 is snap-fit connection, adhesion, etc.

Other structures are the same as those in Embodiment IV, and will not be repeated here.

### Embodiment VI

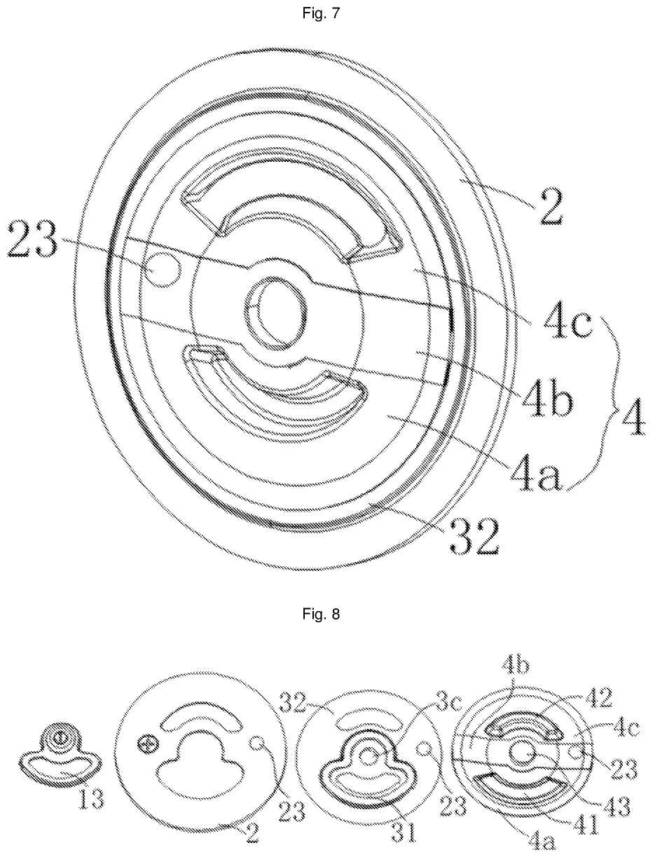

Different from Embodiments IV to V: refer to FIGS. 7-8, the battery cover structure of this embodiment further includes a current collector piece 4; the current collector piece 4 includes a first current collector portion 4a, an insulation connecting portion 4b and a second current collector portion 4c which are connected in sequence, the insulation connecting portion 4b being arranged between the first current collector portion 4a and the second current collector portion 4c; wherein the first current collector portion 4a is provided at the first through port 3a and partly connected to the first weak portion 13, and the second current collector portion 4c is arranged on the second through port 3b and partly connected to the second weak portion 22. The first tab is connected to the third cover 12 by using the first current collector portion 4a, and the second tab is connected to the first cover 2 by using the second current collector portion 4c, and thus the first current collector portion 4a and the second current collector portion 4c effectively improve the stability of connection between the tabs and the covers, and improve the conductive stability and the conductive capability of the battery cover structure.

In the battery cover structure, refer to FIG. 8, a part of the first current collector portion 4a configured to connect with the first weak portion 13 of the third cover 12 is a first raised portion 41, and a part of the second current collector portion 4c configured to connect with the second weak portion 22 of the first cover 2 is a second raised portion 42. The raised heights of the first raised portion 41 and the second raised portion 42 are respectively 0.1 mm-20 mm, thereby effectively shortening the distance between the third cover 12 and the first current collector portion 4a and the distance between the first cover 2 and the second current collector portion 4c. Furthermore, the raised directions of the first raised portion 41 and the second raised portion 42 are the same as the raised directions of the first protrusion 11a and the second protrusion 21, and the shapes of the first raised portion 41 and the second raised portion 42 are respectively adapted to the shapes of the first weak portion 13 and the second weak portion 22.

In the battery cover structure, the connection manner of the first current collector portion 4a, the insulation connecting portion 4b and the second current collector portion 4c are hot melting, adhesion, snap-fit, nano-injection molding, etc. The first current collector portion 4a, the insulation connecting portion 4b and the second current collector portion 4c are stacked on the end of the second insulator 32 facing the negative direction of the battery cover structure. The first raised portion 41 may penetrate through the first through port 3a along the side of the first insulator 31 facing the negative direction of the battery cover structure; and the second raised portion 42 may penetrate through the second through port 3b along the side of the second insulator 32 facing the negative direction of the battery cover structure.

In an embodiment, refer to FIG. 8, the first insulator 31 is provided with a third through port 3c at a part located in the first sub hole 20a, and the third through port 3c and the insulation connecting portion 4b are respectively provided with connecting structures matching each other; wherein the connecting structures are recessed-raised matching structures or clamping structures. For example, the part where the insulation connecting portion 4b matches the third through port 3c is set as a third raised portion 43, and the third raised portion 43 is embedded in the third through port 3c, so as to effectively improve the connection reliability and the assembly firmness of the current collector piece 4 and the insulator 3.

In an embodiment, refer to FIG. 8, the first cover 2, the second insulator 32, and the insulation connecting portion 4b are correspondingly provided with functional holes 23, the functional holes 23 are configured for liquid injection or pressure relief, and the functional hole 23 may serve as an inflow channel of an electrolyte solution or a gas releasing hole for assisting opening of a pressure relief mechanism. In addition, the pressure relief mechanism is directly provided in the functional hole 23 of the first cover 2 after a liquid is injected into the battery.

Other structures are the same as those in Embodiments IV and V, and will not be repeated here.

### Embodiment VII

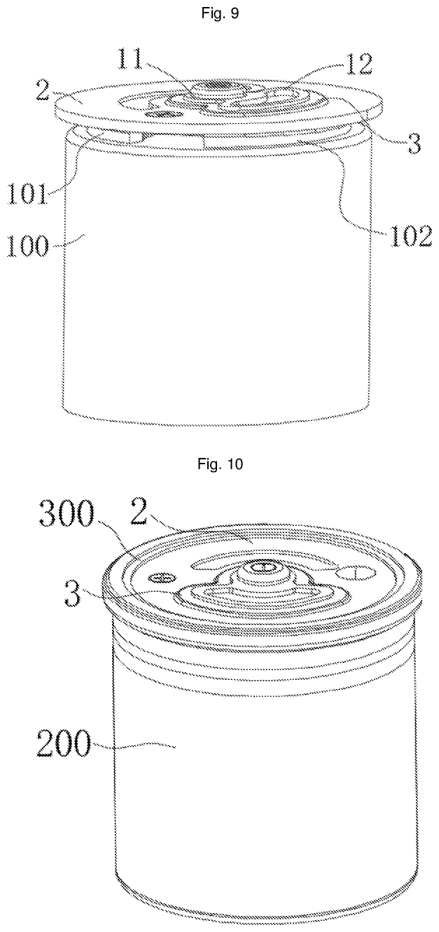

A battery, refer to FIG. 9-10, including the battery cover structure of any one of Embodiments I-VI; furthermore, the battery further includes a cell 100 and a housing 200 provided with an opening at one end; the battery cover structure is connected to the cell 100, the cell 100 is provided inside the housing 200, and the battery cover structure is configured for closing the opening of the housing 200; wherein a positive tab 101 and a negative tab 102 of the cell 100 are both provided on an end of the cell 100 facing the battery cover structure, the end of the negative direction of the battery cover structure is the end of the battery cover structure facing the cell 100, and one of the third cover 12 and the first cover 2 is connected to the positive tab 101, and the other of the third cover 12 and the first cover 2 is connected to the negative tab 102.

In an embodiment, the positive tab 101 and the negative tab 102 both have a semicircular structure, so that the current passing capacity of the battery and the connection strength between the tabs and the covers is improved.

In an embodiment, the housing 200 is made of a steel shell material, has high structural strength and good reliability; and corrosion will occur as the steel shell material is positively charged. Therefore, an insulation sealing member 300 for isolating the housing 200 from the battery cover structure is provided between the battery cover structure and the housing 200, and the packaging process of the insulation sealing member 300 is pier sealing.

In an embodiment, the housing 200 made of a steel shell material is electronegative without insulation processing.

A preparation method for the battery includes the following steps:
preparing a cell 100 of which a positive tab 101 and a negative tab 102 are both located at the same end;
assembling an insulator 3 between a first cover 2 and a second cover 11 and between the first cover 2 and a third cover 12, so that the insulator 3, the first cover 2, the second cover 11 and the third cover 12 form an integrated cover structure;
welding one of the first cover 2 and the third cover 12 to the positive tab 101 of the cell 100, welding the other of the first cover 2 and the third cover 12 to the negative tab of the cell 100, and connecting the second cover 11 to an external connecting member; and
mounting the cell 100 into a housing 200, and connecting an opening of the housing 200 to the first cover 2 in a closed manner.

The external connecting member is an adapter device or an electric device.

### Embodiment VIII

An electric device, including the battery of Embodiment VII; furthermore, the battery is able to be a lithium ion battery, a sodium ion battery, a magnesium ion battery, etc. The electric device is a vehicle, a mobile phone, a portable device, a laptop, a ship, a spacecraft, an electric toy, an electric tool, and the like. The vehicle is a fuel vehicle, a gas vehicle or a new energy vehicle, and the new energy vehicle is a pure electric vehicle, a hybrid electric vehicle or an extended-range vehicle, etc.; the spacecraft includes an aircraft, a rocket, a space shuttle and a spaceship, etc.; the electric toy includes a stationary or mobile electric toy, such as a game machine, an electric vehicle toy, an electric ship toy, and an electric plane toy; and the electric tool includes a metal cutting electric tool, a grinding electric tool, am assembling electric tool and a railway electric tool, for example, an electric drill, an electric sander, an electric spanner, an electric screwdriver, an electric hammer, an electric hammer drill, a concrete vibrator and an electric planer. The embodiments of the present disclosure do not specifically limit the described electric device.

According to the disclosure and teaching of the description above, a person skilled in the field to which the present disclosure belongs would also have been able to make changes and modifications to the embodiments above. Therefore, the present disclosure is not limited to the described specific embodiments, and any obvious improvements, replacements or modifications made by a person skilled in the art on the basis of the present disclosure shall all belong to the scope of protection of the present disclosure. In addition, although some specific terms are used in the present description, these terms are merely used for convenience of illustration and do not constitute any limitation on the present disclosure.

What is claimed is:

1. A battery cover structure, comprising:
a first cover, a second cover and a third cover;
wherein the first cover is provided with a first through hole, the second cover and the third cover are connected and are arranged in the first through hole, the second cover is configured for being electrically connected to an outside, and the third cover is configured for being electrically connected to a first tab;
the second cover and the third cover have the height difference in the first direction, and each of the second cover and the third cover is provided with a welding region;
and an insulator, provided between the first cover and the second cover and between the first cover and the third cover, so as to insulate and isolate the first cover from the second cover, and insulate and isolate the first cover from the third cover.

2. The battery cover structure according to claim 1, wherein the first through hole comprises a first sub hole and a second sub hole in communication with the first sub hole.

3. The battery cover structure according to claim 2, wherein the insulator comprises a first insulator, the first insulator is mounted in the first through hole, a mounting slotted hole corresponding to the first through hole is formed on the first insulator; and the second cover and the third cover are mounted in the mounting slotted hole, the second cover is located in the first sub hole, and the third cover is located in the second sub hole.

4. The battery cover structure according to claim 3, wherein the battery cover structure has the central position, the first sub hole is located at the central position, at least a part of the first cover forms an annular shape, the annular shape is configured for being electrically connected to the outside, and the annular shape surrounds the second cover and the third cover by taking the central position as the center.

5. The battery cover structure according to claim 2, wherein the first sub hole is a part of a circular sub hole cut along a chord, and the arc corresponding to the first sub hole is a major arc.

6. The battery cover structure according to claim 4, wherein a first protrusion is formed on the second cover, and/or a second protrusion is formed on the annular shape of the first cover, the height difference between the first protrusion and the second protrusion is 0.5 mm-5 mm.

7. The battery cover structure according to claim 4, wherein a part of region outside the annular shape in the first cover is configured for being electrically connected to a second tab, and the polarity of the second tab is opposite to that of the first tab.

8. The battery cover structure according to claim 6, wherein a first weak portion for electrically connecting to the first tab is formed on the third cover, a second weak portion for electrically connecting to the second tab is formed on the first cover, and the polarity of the second tab is opposite to that of the first tab, the first weak portion and/or the second weak portion are recessed structures, the first weak portion avoids the first protrusion, and the second weak portion avoids the second protrusion.

9. The battery cover structure according to claim 8, wherein a first raised portion and a first recessed portion are respectively formed at the connection position at the first insulator and the first cover, and the first insulator is clamped with the first cover by the first raised portion and the first recessed portion.

10. The battery cover structure according to claim 9, wherein the second cover and the third cover are connected to form a cover body, a second raised portion and a second recessed portion are respectively formed at the connection position at the cover body and the first insulator, and the first insulator is clamped with the cover body by the second raised portion and the second recessed portion.

11. The battery cover structure according to claim 10, wherein the insulator further comprises a second insulator extending along the periphery of the bottom of the first insulator and covering a part of the bottom surface of the first cover.

12. The battery cover structure according to claim 11, wherein the first insulator is provided with a first through port at a position corresponding to the first weak portion, and the second insulator is provided with a second through port at a position corresponding to the second weak portion.

13. The battery cover structure according to claim 12, further comprising a current collector piece; wherein the current collector piece comprises a first current collector portion, an insulation connecting portion and a second current collector portion which are connected in sequence; the first current collector portion is arranged on the first through port and partially connected to the first weak portion, and the second current collector portion is arranged on the second through port and partially connected to the second weak portion.

14. The battery cover structure according to claim 13, wherein a part of the first current collector portion configured to connect with the third cover is a first raised portion, and a part of the second current collector portion configured to connect with the first cover is a second raised portion.

15. The battery cover structure according to claim 13, wherein a third through port is provided on a part of the first insulator located in the first sub hole, and the third through port and the insulation connecting portion are respectively provided with connecting structures matching each other.

16. The battery cover structure according to claim 13, wherein the first cover, the second insulator, and the insulation connecting portion are correspondingly provided with functional holes, the functional holes are configured for liquid injection or pressure relief.

17. The battery cover structure according to claim 11, wherein
a plurality of nanopores are formed on the first raised portion or the first recessed portion; and/or
a plurality of nanopores are formed on the second raised portion or the second recessed portion; and/or
a plurality of nanopores are provided at the connection position at the first cover and the second insulator, and at least a part of the second insulator is embedded into the nanopores.

18. A battery, comprising a housing provided with an opening at one end, the battery cover structure according to claim 1 for closing the opening, and a cell connected to the battery cover structure; wherein a positive tab and a negative tab of the cell are both provided on an end of the cell facing the battery cover structure.

19. The battery according to claim 18, further comprising an insulation sealing member arranged between the battery cover structure and the housing and isolating the housing from the battery cover structure.

20. An electric device, comprising the battery according to claim 18.
